(19) United States
(12) Patent Application Publication
(10) Pub. No.: US 2002/0184260 A1
(43) Pub. Date: Dec. 5, 2002

(54) Multidimensional data entry in a spreadsheet

(76) Inventors: Paul Martin, Essex (GB); William Angold, Surrey (GB); Nicolaas Kichenbrand, Surrey (GB)

Correspondence Address: ERIC L. PRAHL, Fish & Richardson P.C., 225 Franklin Street, Boston, MA, 02110-2804, US

(21) Appl. No.: 09/886,657

(22) Filed: Jun. 21, 2001

Related U.S. Application Data
(60) Provisional application No. 60/294,494, filed on May 30, 2001.

(51) Int. Cl. G06F 15/00

(52) U.S. Cl. 707/503; 345/809

(57) ABSTRACT

A computer-based method for multi-dimensional data entry in a spreadsheet application by a user is disclosed. The method includes providing a multi-dimensional data storage source and configuring a spreadsheet to display elements of the multi-dimensional data storage in an initial unedited state. The user can edit a data value of an element. The method also includes displaying the edited data values in the spreadsheet and allowing the user at least the option to commit the edited data values to the multi-dimensional data storage, and the option to return the multi-dimensional data storage to the initial unedited state.

### TECHNICAL FIELD

This invention relates to computer information systems, and more particularly to spreadsheet applications and multi-dimensional databases.

### BACKGROUND

Spreadsheet applications display data in sheets having rows and columns. Spreadsheet applications are a useful tool for viewing and editing tabular data, i.e. data that fits into rows and columns. For example, as of the writing of this application, the most popular spreadsheet application on the market is Microsoft® Excel (“Excel”), sold by Microsoft Corporation of Redmond, Wash., USA. Excel is one of the top-selling pieces of software of any description. Many computer users are familiar with its tools and techniques.

Many types of information that have simple repeated data structures can be represented in a table, and therefore in a spreadsheet application. For instance, spreadsheet columns may represent the repeated elements of the data structure (sometimes known as “fields”) while rows represent each instance of the information structure, or “record.” Other orientations are possible, too. For example, a carpenter might keep his lumber inventory in a spreadsheet using columns for linear measures such as height, width, and length. Additional information might include the grade of the lumber, where grade is chosen from a short list of possible values, plus an integer value for quantity on hand. The first row would label each column, while subsequent rows would represent the inventory of each group of lumber. For simple inventory purposes, this might be sufficient to the carpenter's needs.

However, some information is more usefully represented in multi-dimensional form. Suppose the carpenter also wanted information about the wood itself, categorizing softwoods such as balsa and pine as well as hardwoods like maple and oak. This categorization is known as a dimension. A dimension may contain, as in this example, hierarchies. This particular hierarchy works as follows: at a first level, it can consider softwood versus hardwood; at a second level, it can consider the particular tree; and, there could be subsequent levels, such as dividing pine into white pine and yellow pine. Information that is dimensional in this way is unwieldy for a spreadsheet to store. By contrast, multi-dimensional databases have been designed specifically for this purpose.

Multi-dimensional databases allow a user to view dimensional data at each of its levels and across multiple dimensions. In the process, there is usually a numeric “measure” dimension being aggregated; the type of wood in the lumber inventory, for example, is of little use for inventory purposes unless it can be compared to the quantity on hand. Thus, a multi-dimensional database might have a dimension for wood type and a measure for quantity. This is why the databases are called multi-dimensional: multiple independent dimensions may be defined over the data. A collection of n dimensions and measures (as data structures) together with the information inside the structures is called a “n-cube,” or “cube” for short.

Often, a cube includes a time-based dimension. Time can be hierarchically represented using levels that contain, for instance, year, quarter, and month. Suppose the carpenter wanted to track the date each piece of wood was milled, so that particularly well-aged pieces could be set aside for fine cabinetry. A multi-dimensional database could support a view of his data showing the quantity of his hardwoods grouped by year; another view into the same data set might show only maple, and aggregate the quantity by month. These sorts of view are “slices” of the cube. A slice is defined by holding a member (or set of members) constant and letting the rest of the cube's dimensions and members vary.

The ability to choose slices for various perspectives on data is one reason multidimensional databases can process information in useful ways not available to tabular-data engines. However, the software available for accessing multi-dimensional databases has, to date, not achieved the widespread use that spreadsheet applications have achieved.

An example of a multi-dimensional database product is Microsoft® SQL Server™ 2000 Analysis Services (“Analysis Services”), also a product of Microsoft Corporation of Redmond, Wash., USA. The syntax for definition and manipulation of multi-dimensional objects and data in Analysis Services is known as “MDX,” an acronym for Multidimensional Expressions. Other vendors such as Oracle Corp., of Redwood Shores, Calif., USA, sell comparable products.

Following are some additional concepts and terminology for multi-dimensional databases.

A multi-dimensional database usually has a data-definition language, or DDL, which includes commands for configuring data structures in the database. For a multi-dimensional database, for instance, the DDL can be used to create, delete, and modify cubes and cube elements. MDX can act as a DDL for Analysis Services.

A member is an element within a dimension. A member belongs to exactly one dimension; it also belongs to exactly one of the dimension's levels; and by the nature of hierarchies, any member below the first level belongs to one member on each level above it in the hierarchy. A member can be written in the following notation if its name is unique among the members of its dimension:

[Dimension name].[Member name]

In general, a member can be written as:

[Dimension name].[Hierarchy name].[Level name].[Member name]

Some multi-dimensional databases, for example Analysis Services, support calculated members, defined using calculation rules. The calculation rules may draw upon values from multiple dimensions. For example, in the lumber inventory cube, suppose the measures include “quantity on hand” and “quantity committed to projects.” A calculated member might be “quantity available,” defined as the quantity on hand less the quantity committed to projects. MDX includes features for defining a calculated member's formula.

By holding a member (or set of members) constant and letting the rest of the cube's dimensions and members vary, one can look at a “slice” of the cube data. A slice will usually contain a series of measure values. A slice is a view of the cube that contains one member for each background dimension plus all selected members for all row and column dimensions. A “tuple” is a collection of members. The notation for tuples is a comma-separated list, enclosed in parentheses. A tuple defines a slice; conversely, if you list the members held constant by a slice, a slice defines a tuple. Thus, the two are closely related. “Tuple” usually refers to the expression, while “slice” usually refers to the associated data.

A “cube cell” as we shall use the term is a slice that has at least one member specified for every available dimension (except the measures—the cube cell has a value for each measure). An “intersect” of a cube has at least one member specified for every available dimension, and also has exactly one specified member of a measure. Thus, an intersect is a cube cell that has one measure member specified.

A “parent cell” is a cell that, in at least one of its dimensions, is not at the lowest possible level. That is, one of its members has children beneath it in at least one hierarchy. A “calculated cell” is a cell whose value is based on a formula and derives its measure values, via the formula, from the measures of others. Thus, a calculated cell is not unlike a formula cell in a spreadsheet. The formula may cause the values of a calculated cell to depend on several other cells or slices.

### SUMMARY

In general, in one aspect, the invention is a computer-based method for multi-dimensional data entry in a spreadsheet application by a user. The method includes providing a multidimensional data storage source and configuring a spreadsheet to display a plurality of elements of the multi-dimensional data storage in an initial unedited state. The user can edit a data value of an element in the plurality of elements. The method also includes displaying the edited data values in the spreadsheet and allowing the user at least two options. One option is to commit the edited data values to the multi-dimensional data storage. A second option is to return the multidimensional data storage to the initial unedited state.

Preferred embodiments include one or more of the following features. Spreadsheet-based data structures are used to enable a correspondence between a spreadsheet data cell and a cell in the multi-dimensional data storage source. Edited data values are stored individually in a data storage source separate from the multi-dimensional data storage source. The user is allowed to discard an edit to the edited data values without discarding every such edit. An interactive dialog wizard guides at least part of the user's interaction with the method. The method is implemented as an add-in to the spreadsheet application.

In general, in another aspect, the invention is a computer apparatus for multi-dimensional data entry in a spreadsheet application. The apparatus includes a central processing unit, random-access memory, a storage device, and devices for user input and output interconnected by a bus, together with computer-readable instructions capable of causing the processing unit to perform steps with a user. The steps include providing a multi-dimensional data storage source; configuring a spreadsheet to display a plurality of elements of the multi-dimensional data storage in an initial unedited state; allowing the user to edit a data value of an element in the plurality of elements; displaying the edited data values in the spreadsheet; and allowing the user to discard an edit to the edited data values without discarding every such edit. An additional step includes allowing the user at least two options: to commit the edited data values to the multi-dimensional data storage; and to return the multi-dimensional data storage to the initial unedited state.

The invention makes it possible for a user to use a spreadsheet to view and edit data stored in a cube. The cube may provide aggregate views of the data, optimized response times to certain queries, or other information processing features that were not available using the spreadsheet alone. Additional benefits can occur for users who prefer a spreadsheet application over other information analysis tools. For such users, the invention allows their first choice of tool to be used on data within a cube.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of a spreadsheet application with processes for multidimensional data extraction and editing.

FIG. 1B is a block diagram of a computing platform for a spreadsheet application.

FIG. 1C is a block diagram of a spreadsheet application with a wizard process.

FIG. 1D is a block diagram of a spreadsheet application with an add-in facility.

FIG. 2 illustrates a commit process and a rollback process.

FIG. 3A is a flowchart of a capture process.

FIG. 3B is a flowchart of a spreadsheet selection process.

FIG. 4 is a block diagram of a spreadsheet configuration.

FIG. 5 is a flowchart of a process to capture multi-dimensional edits.

FIG. 6 is a flowchart of a map to storage process.

FIG. 7 shows data structures for storage.

FIG. 8 is a block diagram of a commit process.

FIG. 9 is a block diagram of a rollback process.

Like reference symbols in the various drawings indicate like elements.

### DETAILED DESCRIPTION

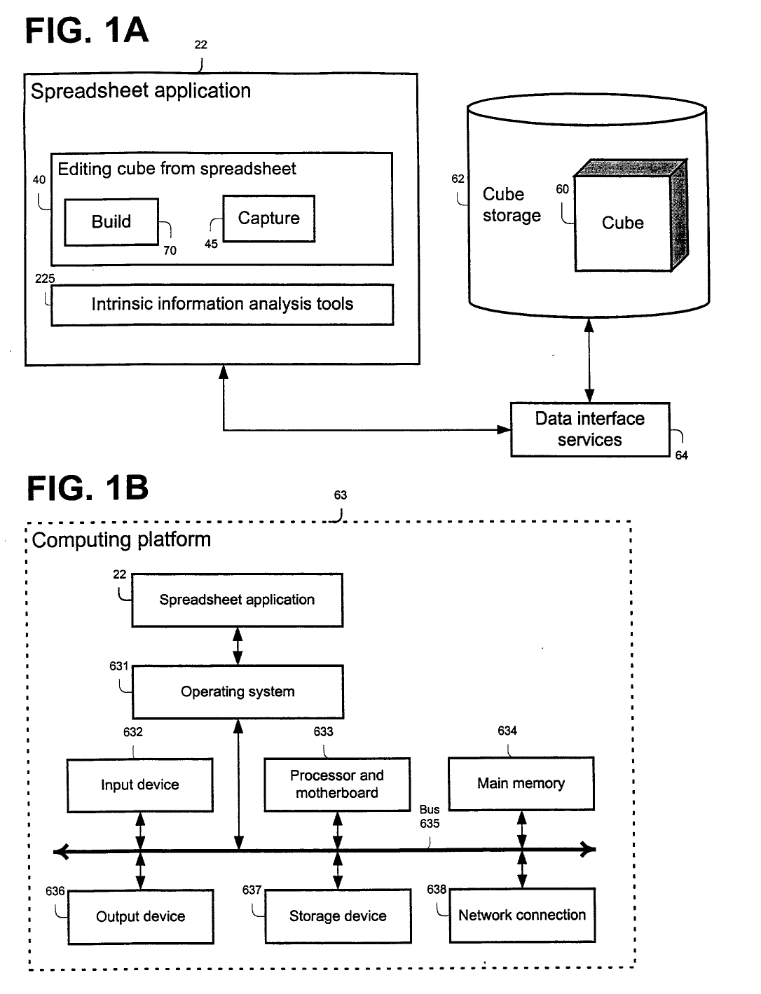

In one embodiment, with reference to FIG. 1A, a spreadsheet application 22 has an editing process 40, for viewing and editing data stored in a cube 60. The spreadsheet application 22 is implemented in software running on a computing platform 63, shown in FIG. 1B.

Overview

As will be described in more detail below, a user, not shown, can apply the editing process 40 to edit data stored in an existing cube 60. The user can thereby use features of the cube 60 to arrange a particularly convenient or appropriate view of the data, such as might be uniquely possibly within a multidimensional data structure, and edit the data in that arrangement. Before saving the edited version of the data permanently, the user can choose to discard some or all of the edits.

An advantage of the described embodiment is that the user can use the spreadsheet application 22 as an information-analyzing environment for information in the cube 60. This can be especially useful when the user is already familiar with the use of intrinsic information analysis tools 225 in the spreadsheet application 22. Intrinsic information analysis tools 225 may include features for formatting and exporting information as well as analytical tools such as what-if scenarios, problem solving, numeric calculations, and other features known to those skilled in the art. The range of tools intrinsic to the spreadsheet application 22 is not central to the described invention and will not be described exhaustively here; the tools 225 are cited, among other reasons, to show a benefit to using a spreadsheet application 22 with respect to multi-dimensional data access.

Another benefit to using a cube 60 is that the cube 60 may include features that were not intrinsically available from within the spreadsheet application 22, such as the ability to view a slice that intersects the dimensional hierarchies of the cube 60 at various levels. Also, the engine of a multi-dimensional database will often pre-compute the aggregations on its measures, providing significantly improved response times (as compared with queries that are not pre-computed).

Computing Environment

FIG. 1A shows a spreadsheet application 22 that can access a cube storage 62 via data interface services 64. In the present embodiment, the spreadsheet application 22 is Excel. The data interface services 64 includes ADO (Active Data Objects) and DAO (Data Access Objects) implementations such as those provided by Microsoft. The data interface services 64 may also include ProClarity connectivity. ProClarity is manufactured by ProClarity Corporation, Inc. Using ADO, DAO, and ProClarity to provide data services to software applications is well known in the art.

In the present embodiment, the cube storage 62 may include software for database and other data storage services, such as Microsoft® Access 2000 and the Microsoft Jet database engine, or Microsoft® SQL Server™ 2000, all of which are products of Microsoft Corp. The cube storage 62 supports a DML (data manipulation language) appropriate to the data storage software, such as MDX (Multidimensional Expressions) for Microsoft SQL Server 2000 Analysis Services. The cube storage 62 may be a database or a combination of databases. The cube storage 62 includes a cube 60 that can act as a multidimensional data source. The cube 60 contains structures for data and can also contain the data itself. The cube 60 may have as few as one dimension or as many dimensions as its storage devices and underlying software will support. (In an unconfigured state, the cube 60 has no dimensions.)

The spreadsheet application 22 has access to a variety of services and devices, shown in FIG. 1B. The spreadsheet application 22 runs on a computing platform 63 that includes an operating system 631 such as Microsoft Windows 98. The operating system 631 is a software process, or set of computer instructions, resident in either main memory 634 or a storage device 637 or both.

A processor and motherboard 633 contains at least one processor that can access main memory 634 to execute the computer instructions that describe the operating system 631 and the spreadsheet application 22.

The user interacts with the computing platform via an input device 632 and an output device 636. For Windows 98, possible input devices 632 include a keyboard, a microphone, a touch-sensitive screen and a pointing device such as a mouse; possible output devices 636 include a display screen, a speaker, and a printer.

The storage device 637 includes a computer-writable and computer-readable medium, such as a disk drive. A bus 635 interconnects the processor and motherboard 633, the input device 632, the output device 636, the storage device 637, main memory 634, and optional network connection 638. The network connection 638 includes a device and software driver to provide network functionality, such as an Ethernet card configured to run TCP/IP, for example.

As is known in the art, when a network connection 638 is present and connected to a network with other hosts, not shown, the cube storage 62 need not be hosted on the same computing platform as the spreadsheet application 22. That is, cube storage 62 may be available remote via a network connection 638. For instance, the data interface services 64 may perform data remoting services transparently to the spreadsheet application 22, as is well known in the art. For the sake of simplicity, however, the description of the present embodiment will refer to cube storage 62 as though it were local to the spreadsheet application 22.

In the present embodiment, the editing process 40 is written in the programming environment Microsoft® Visual Basic™, which is another product of Microsoft Corp. Some components may be written in other languages such as C++ or Delphi and incorporated into the main body of software code via component standards such as COM (Common Object Model) or OLE (Object Linking and Embedding), as is known in the art.

Editing

The editing process 40 configures a spreadsheet for connection to a cube 60. In one embodiment, the spreadsheet is Excel. The configuring includes preparing a user interface to present data from the cube 60 to a user. The user can then edit this data and selectively save or reject changes. The editing process 40 is a software program or set of computer instructions capable of interacting with the spreadsheet application 22 via interfaces that the spreadsheet exposes, such as OLE or an internal scripting environment like Visual Basic for Applications.

With reference once more to FIG. 1A, the editing process 40 includes a build process 70 and a capture process 45.

Build

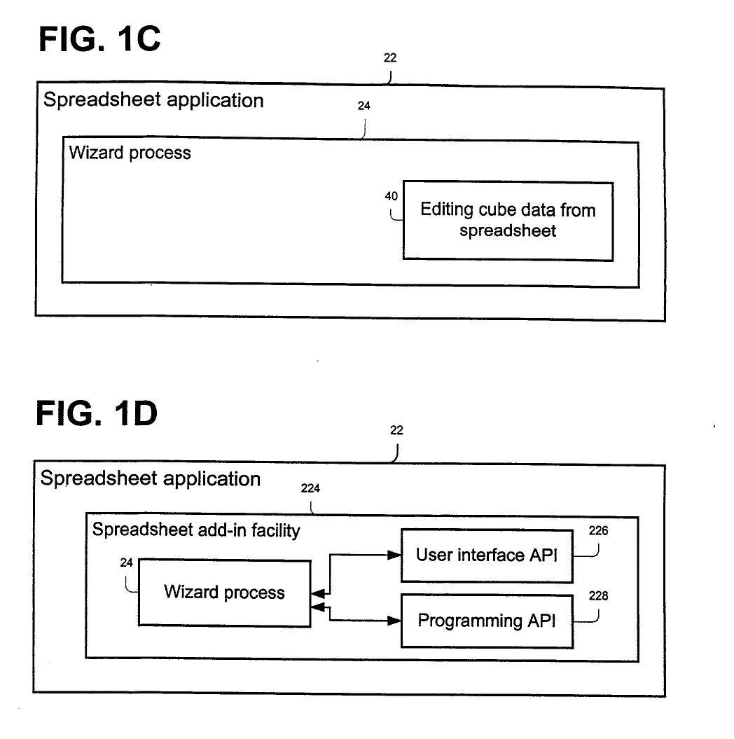

FIG. 2 shows a build process 70 that can configure the spreadsheet application 22 for connection to a cube 60. The build process 70 may be performed in at least two modes: interactively with a user who provides input, or in response to a set of instructions from a data source (not shown). The set of instructions may come from another computing process or a configuration file containing parameters that determine the output of the build process 70. The set of instructions may also be embedded in a spreadsheet file as configuration parameters or as a macro. Macros in spreadsheets are known in the art.

The build process 70 includes a select cube process 82 for identifying at least one cube 60 for use by the spreadsheet application 22. Multiple cubes 60 may be identified. For example, one method for identifying a cube 60 includes specifying the information necessary for a database driver to make its own direct connection to a database file included in cube storage 62. Many other methods for connecting to database sources are well known in the art and may be substituted, however. Such methods include but are not limited to proxied connections rather than direct connections, remote databases rather than local ones, and connections whose configurations are pre-configured and made available in storage on the current instance of the computing platform. One example of a plurality of pre-configured connections, when the computing platform is Microsoft Windows, is the collection of “user”, “system”, and “file” DSNs (Data Source Names) for ODBC, as is known in the art.

The build process 70 further includes a process to select orientation 83. Select orientation 83 associates an axis of a data structure from a cube 60, with a display axis in a spreadsheet. The display axes in a spreadsheet include a row axis and a column axis. As is well known in the art, a cube may contain a number of dimensions. Each of these dimensions provide a different view of the data and can be represented in the display device as a rows, columns and background dimensions. Each background dimension shows data for a single member from that dimension, while row and column dimensions show data for all selected members. For instance, a spreadsheet application 22 includes cells organized in at least two physical dimensions known as rows and columns. Various UI techniques exist for representing additional axes within a spreadsheet application 22, such as multiple sheets, visual overlays, coloring, etc. For each such display axis that the spreadsheet application 22 presents to the user, the select orientation process 83 can allocate the display axis for use by a data axis. The display axis of a cube's dimension is known as its orientation.

The build process 70 selects a member of a dimension for display (step 84) and repeats member selections in a loop until terminated (step 85). Once the loop terminates, the build process 70 configures a spreadsheet for data entry (step 86). Configuring 86 includes a subprocess 362 that uses the data interface services 64 to open at least one data connection to a cube 60. The data interface services 64 may include ADO services and may include ProClarity services. Opening data connections via ADO and ProClarity are well known in the art.

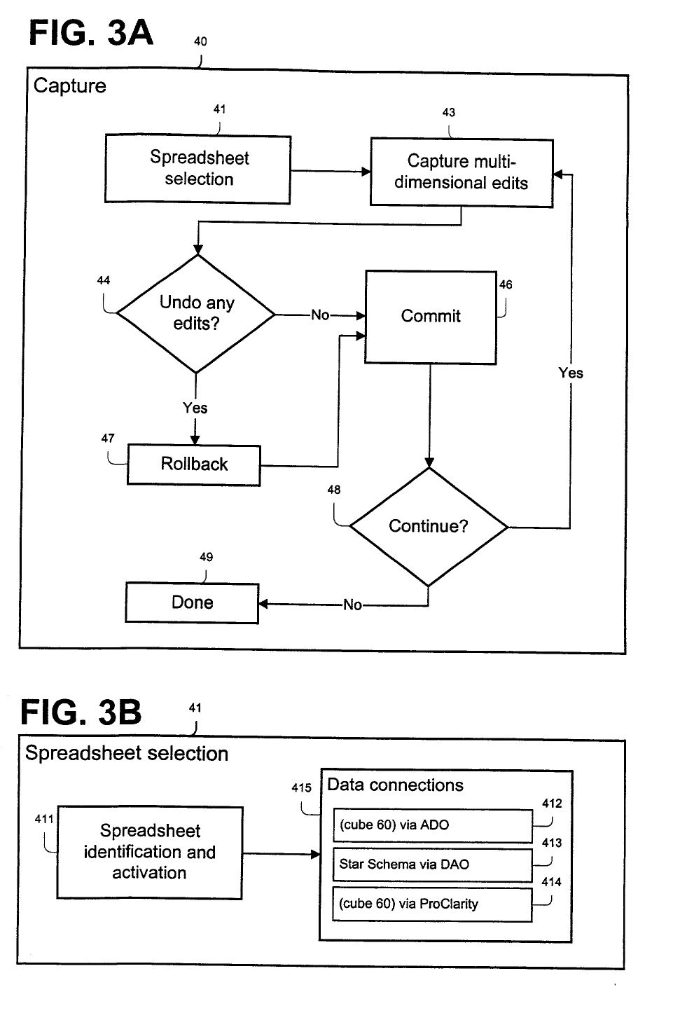

The configure step 86 also includes a subprocess 364 that configures a spreadsheet 50 (shown in FIG. 4). Spreadsheet 50 is available to the spreadsheet application 22 for multidimensional data entry. The spreadsheet configuration process 364 includes configuring user interface elements of the spreadsheet 50 to display the data entities (members, dimensions, slices, etc.) selected in steps 84 and 85.

Spreadsheet Configuration

FIG. 4 shows some of the elements configured by the spreadsheet configuration process 364. In broad terms, the spreadsheet configuration process 364 creates a data entry sheet 50 for the user to interact with. The data entry sheet 50 presents data from a cube 60 for editing. The spreadsheet configuration process 364 also creates data structures for its own bookkeeping, that is, data structures which associate cells of the data entry sheet 50 with cube cells 65. The data structures enable correspondences between various classes of cells, with the objective of creating a correspondence 59 between a data cell 529 and a cube cell.

The spreadsheet configuration process 364 includes identifying a spreadsheet 50 open within the spreadsheet application 22. If no such spreadsheet 50 is specified, the spreadsheet configuration process 364 may create one.

The spreadsheet 50 includes a plurality of subsheets. The plurality includes a data entry sheet 52, a detail sheet 54, a coordinate sheet 56, and a link sheet 58. If the spreadsheet application 22 is Excel, subsheets (known in Excel as “sheets” or “worksheets”) contained within a single spreadsheet are a well-known feature. Similar features exist in other spreadsheet applications known in the art. In the description of the present embodiment that follows, the description assumes that the plurality of subsheets is wholly contained in one spreadsheet 50, for at least the following reasons. There are certain advantages to having the subsheets in a common spreadsheet 50: the plurality of subsheets is handled as a group in a natural way, namely, whenever the spreadsheet 50 is handled, such as opening, closing, saving, being searched for by filename, and so forth. The assumption that spreadsheet 50 is a single, unified file is optional, however. In some embodiments there can be persuasive reasons to distribute the plurality of subsheets across multiple spreadsheets 50—for instance, to store a subset of the plurality locally while storing a second distinct subset on a remote server. For the sake of clarity, however, this description refers to the plurality of subsheets as though it were contained in one spreadsheet file, the spreadsheet 50, as indicated in FIG. 4. Also for the sake of clarity, the following description refers to the subsheets as though they were distinct subsheet entities. Indeed, in one embodiment, the subsheets can be distinct entities within the spreadsheet 50. However, in an alternative embodiment, the features of the subsheets could be provided by an arbitrary number of subsheets.

The spreadsheet 50 includes a data entry sheet 52 that acts as the primary user interface for data entry. The data entry sheet 52 includes the visual presentation of the values and labels of the multi-dimensional data entities in a cell range 525 containing data cells 529 and perhaps non-data cells 523. Data cells 529 display data values and may be available for user data entry. Non-data cells 523 may be used for other purposes, including captions and formatting.

The data entry sheet 52 contains features for manipulating and editing the multi-dimensional data entities such as slice controls 521, column controls 522, and row controls 523. The data entry sheet 52 also features the ability (not shown in figure) to notify the capture process 45 (explained below) of events related to user actions such as edits, navigations, changes of control focus, and so forth, as is well known in the art.

The spreadsheet 50 includes a detail sheet 54. The detail sheet 54 holds information 542 needed to re-connect the spreadsheet 50 to data sources including the cube 60. The detail sheet 54 also includes information 544 about the data entities for display, such as the row dimensions, column dimensions, and slice dimensions.

The link sheet 58 includes a link cell range 585 containing link cells 589. For every data cell 529, there exists a unique link cell 589 containing a reference to the address of its counterpart data cell 529. The relationship between each data cell 529 and link cell 589 is represented by a correspondence 53. One advantage of using the link cells 589 to hold references to the data cells 529 is that it enables the spreadsheet application 22 to rearrange (or even hide) the display locations of the data cells 529, as long as the references in the link cells 589 are kept up to date. Subroutines that need to refer to data cells 529 can refer to them indirectly, via the link cells 589, with the assurance that the reference will be accurate. This reference scheme is analogous to pointer indirection, a technique well known in the art.

The coordinate sheet 56 includes a coordinate cell range 565 containing coordinate cells 569. For every link cell 589, there exists a unique coordinate cell 569. The relationship between each link cell 589 and coordinate cell 569 is represented by a correspondence 55. In one embodiment, the coordinate cell range 565 can be laid out so that the addresses of its cells, as measured within coordinate sheet 56, are identical to the addresses of corresponding cells in the link cell range 585, as measured within link sheet 58. A layout of this kind provides a quick and simple implementation of the correspondence 55.

At least some coordinate cells 569 describe storage coordinates of cube cells 65 within the cube 60. The relationship between each coordinate cell 569 and cube cell 65 is represented by a correspondence 57. Some cells within the cell range 525 might not correspond to cube cells 65. For instance, some cells within the cell range 525 might be used for captions or for formatting purposes within the display.

For data cells 529 corresponding to storage locations in the cube 60, though, a correspondence 59 exists. A correspondence 59 must exist in some form so that the spreadsheet application 22 can pass edits performed in data cells 529 into storage in cube cells 65. For this implementation, the correspondence 59 may be defined as the composition of correspondences 53, 55, and 57. Alternate embodiments may choose different ways of establishing a correspondence 59.

The build process 70 optionally includes a step for storing configuration information for re-use (step 87). The configuration information may be stored in a variety of ways known in the art for storing machine-readable information, such as in a file, in an operating system registry, or in a database.

Capture

The capture process 45 accepts input into the spreadsheet application 22 from a user. The input includes edits to data in the cube 60. The capture process 45 displays any edited values, updates entities whose values depend on calculations involving the edited entities, and allows the user to selectively commit the edits to cube storage 62.

As will be explained in more detail, the user's edits to the cube can be captured and stored in a database table, which, in one role, acts as a log that can be used for commit and rollback purposes. In other words, before committing changes to the cube 60 permanently, the user can excerpt individual edits from a batch of edits to be committed, or can discard the batch altogether.

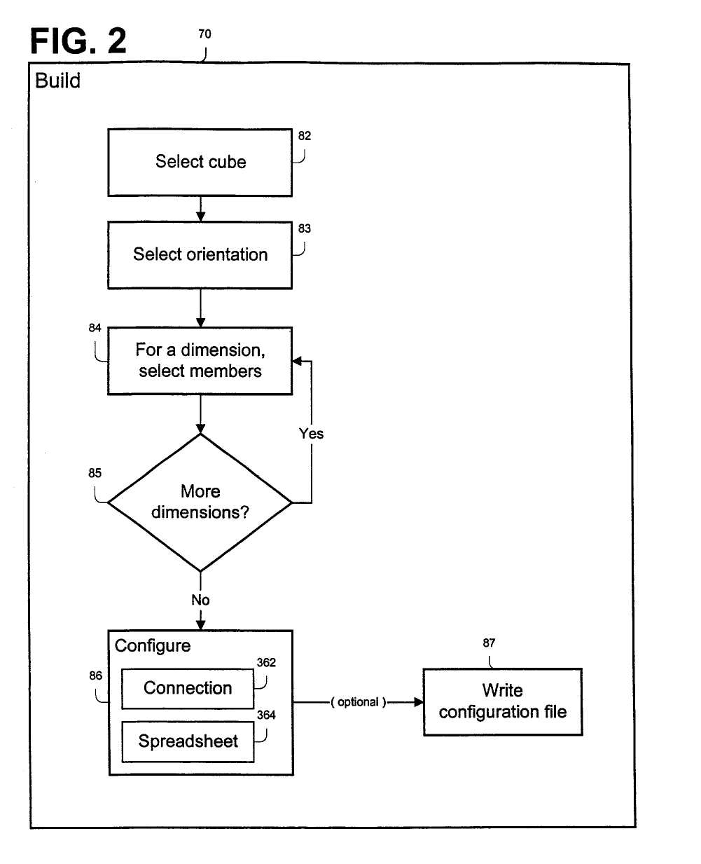

With regard to FIG. 3A, the capture process 45 includes a spreadsheet selection process 41. The spreadsheet selection process 41 specifies an input spreadsheet 50, available to the spreadsheet application 22, prepared to receive user edits to multidimensional data. When the capture process 45 is performed after the build process 70, the input spreadsheet may be the spreadsheet 50 configured by the configure step 86.

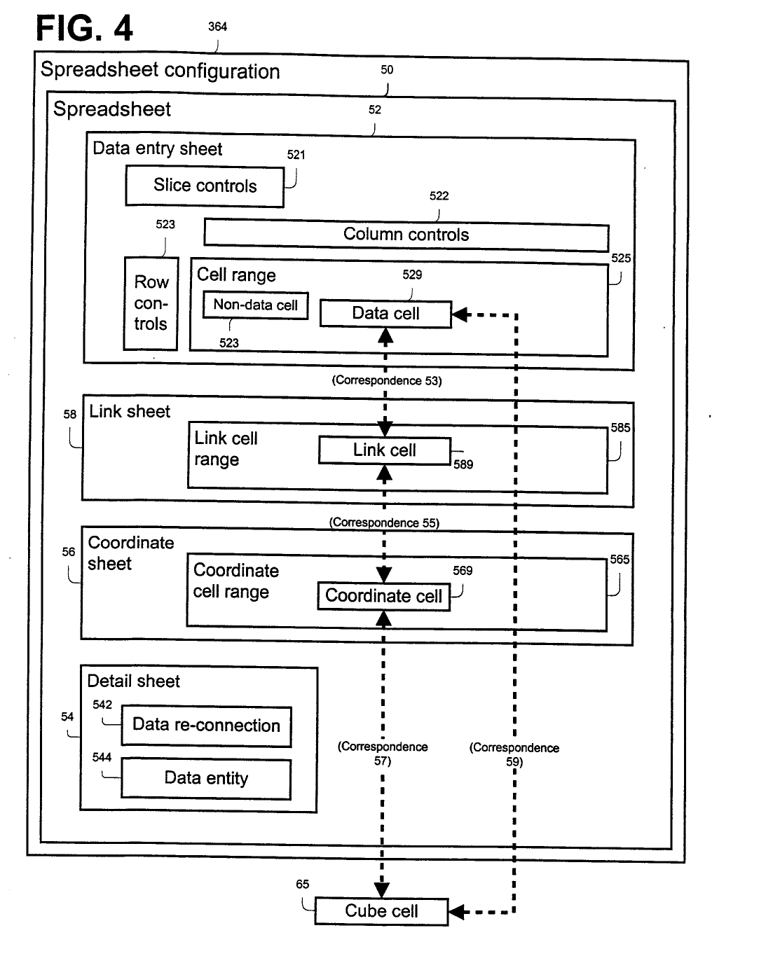

Once the input spreadsheet 50 is known, the capture process 45 includes a process to capture multi-dimensional edits 43, explained in more detail in FIG. 5.

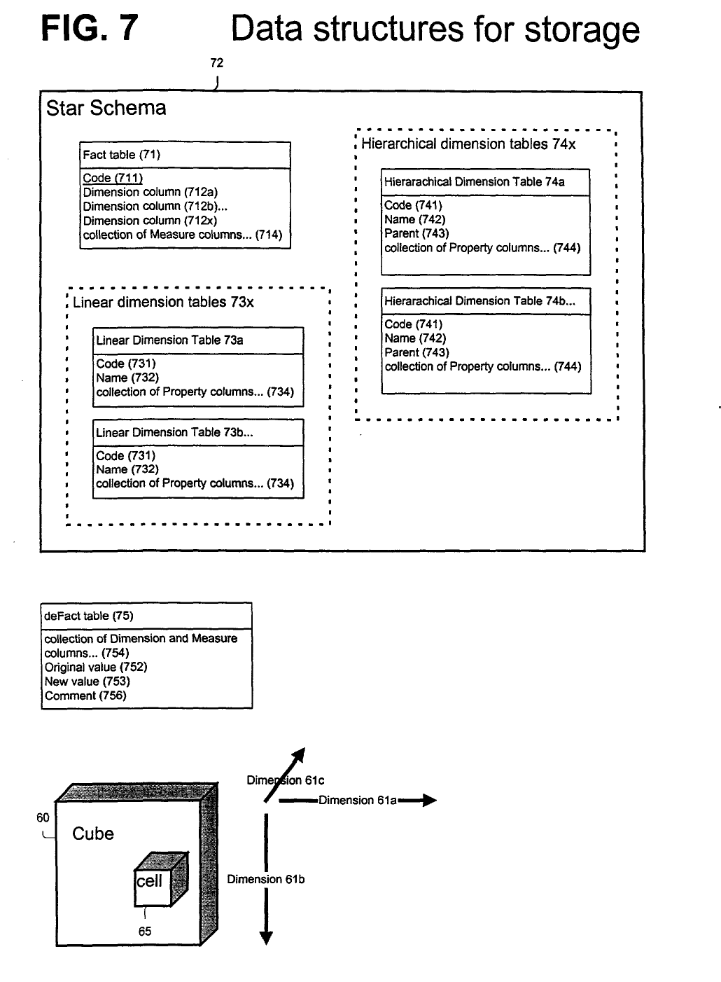

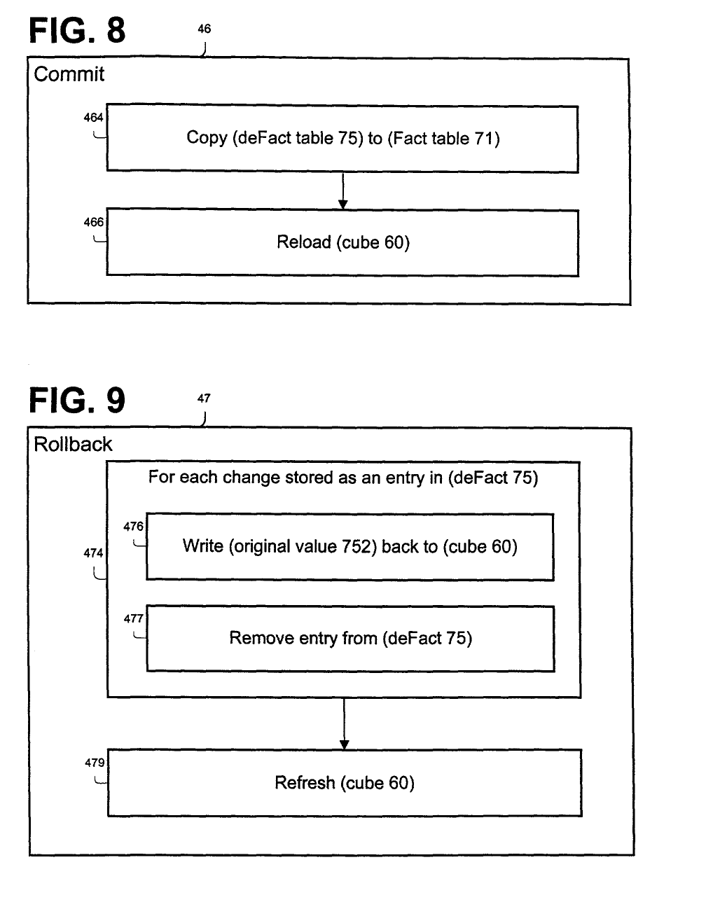

The user may select one or more edits to cube 60 to be undone (step 44); if so, the capture process 45 rolls back the selected edits in a rollback process 47 (described in more detail, below, with regard to FIG. 9). Following the rollback, or if no edits were rolled back, the capture process 45 commits any remaining edits in a commit process 46 (also described in more detail, with regard to FIG. 8).

The capture process 45 continues to loop back to capture multi-dimensional edits 43 until the user cancels the loop (step 48). When the loop is cancelled, the capture process 45 is complete (step 49).

Spreadsheet Selection

FIG. 3B shows details of the spreadsheet selection process 41. When a spreadsheet 50 for data entry is selected and activated by the user (step 411), the spreadsheet selection process 41 makes data connections (step 415). The data connections are made via the data interface services 64 and include: a first connection to the cube 60 via ADO (step 412); a connection via DAO to the Star Schema, which contains a table for data entry (step 413); and a second connection to the cube 60 via ProClarity (step 414).

Capture Multi-Dimensional Edits

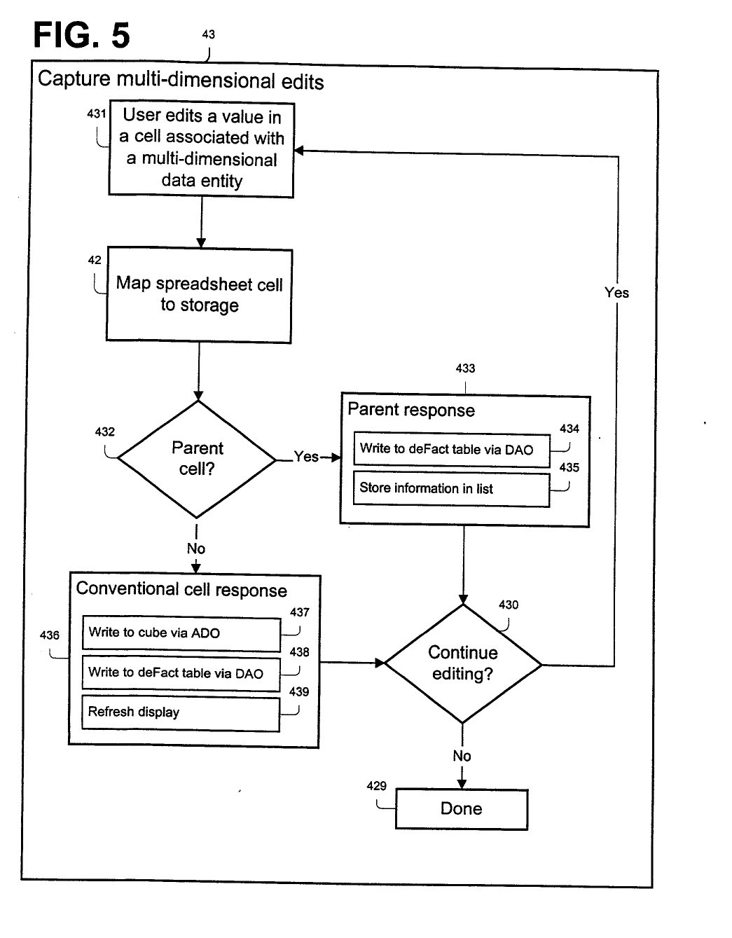

FIG. 5 shows detailed steps in the capture multi-dimensional edits process 43. The user edits a value in a data cell 529 (step 431), such as the data cell 529 shown earlier in FIG. 4, associated with a cube cell 65 via correspondence 59. The capture process 45 determines the associated cube cell 65 (process 42, explained in more detail in FIG. 6), mapping the spreadsheet cell to storage.

The data cell 529 is associated with the value of a measure of the cube cell 65. The cube cell 65 may be a parent cell: a cell that, in at least one of its dimensions, is not at the lowest possible level. Alternatively, a cube cell 65 might be an atomic cell, meaning that it is at the lowest possible level in every dimension it belongs to. Note that if none of the dimensions to which a cube cell 65 belongs is hierarchical, the cube cell 65 is necessarily an atomic cell. Note also that a third type of cell, the calculated cell, cannot be a target of data entry; the values in a calculated cell are derivatives of other cells' values and cannot be edited directly. Non-calculated cells may be called “fact” cells.

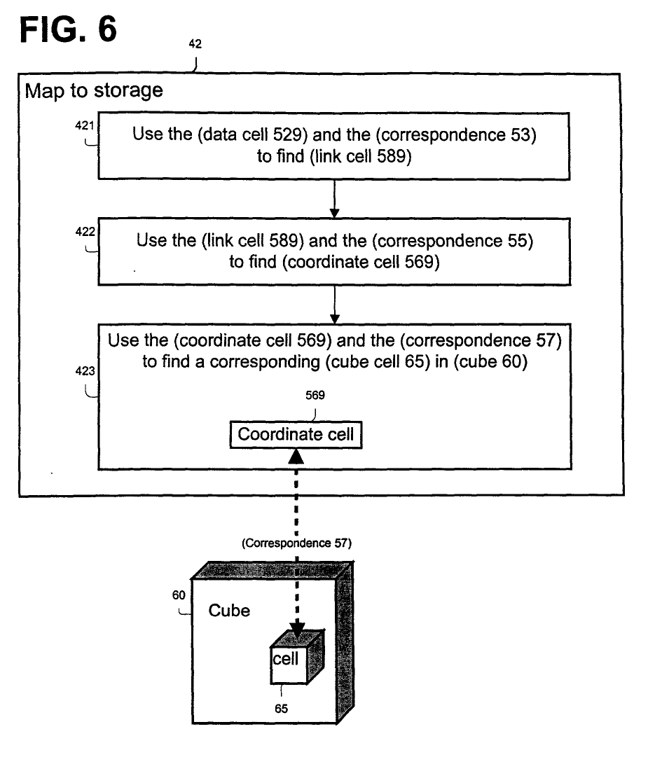

If the data cell 529 is a parent cell (step 432), the capture multi-dimensional edits process 43 responds (step 433) by writing the edit via DAO to the deFact table 75 (shown in FIG. 7) as well as by storing the edit in an internal list (step 435). If the data cell 529 is an atomic cell (another possible outcome of step 432), the capture multi-dimensional edits process 43 responds (step 436) by writing the edit to cube 60 via ADO (step 437); also writing the edit to the deFact table 75 via DAO (step 438); and refreshing the display (step 439).

Writing the edit to the deFact table 75 (step 438) may include: creating an entry in the deFact table 75 to track the edit; populating the original value column 752 with the value of the cube cell 65 prior to the edit; populating the new value column 753 with the new value set by the edit; optionally, populating the comment column 756 with a comment; and saving the entry.

The user then has a choice to continue editing (step 430); if the user chooses to stop editing, the capture multi-dimensional edits process 43 terminates (step 429).

Map to Storage

FIG. 6 shows steps in one embodiment of the map to storage process 42, which maps the data cell 529 to a cube cell 65. There are certain advantages, which will be discussed below, to this embodiment, but the map to storage process 42 may be accomplished in other ways, as long as a storage location within the cube 60 can be found for each data cell 529.

The map to storage process 42 uses the data cell 529 and the correspondence 53 to find a link cell 589 (step 421). Link cells 589 contain references to data cells 529, such that the link cell range 585 may be searched for link cells 589 to discover a match for any given data cell 529 (step 423); this system of references to data cells 529 enables the correspondence 53. Other correspondences may be used; for instance, the correspondence 59 may be calculated and stored.

One advantage of the link cell reference arrangement with regard to Excel is that Excel will automatically maintain the cell references contained in the link cells 589 if the user subjects the cell range 525 to operations such as sorts, inserts, and moves. This enables the user to interact with the cell range 525 much as though it were atomic spreadsheet data, without disturbing the inner workings of the cells correspondences used by the map to storage process 42 and others.

The link cell 589 and the correspondence 55 together specify a coordinate cell 569 (step 422). Likewise, the coordinate cell 569 and the correspondence 57 together specify a cube cell 65 (step 423). The mapping of a cube cell 65 is therefore complete.

Data Structures for Storage

FIG. 7 shows data structures for storage.

The Star Schema 72 includes a Fact table 71 and a collection of linear dimension tables 73a, 73b, etc., such that there is one linear dimension table 73 per dimension defined in cube 60 except measures. The Star Schema 72 further includes a collection of hierarchical dimension tables 74a, 74b, etc., such that there is one hierarchical dimension table 74 per dimension defined in cube 60 except measure dimensions

Each linear dimension table 73 corresponds uniquely to a linear dimension in the cube 60 and includes: a code column 731 as a foreign key referencing the Fact table 71; a name column 732 containing the name of its corresponding dimension in the cube 60; and a property column 734 for each defined property of the corresponding dimension in the cube 60.

Each hierarchical dimension table 74 corresponds uniquely to a hierarchical dimension in the cube 60 and includes: a code column 741 as a foreign key referencing the Fact table 71; a name column 742 containing the name of its corresponding dimension in the cube 60; a parent column 743 containing the name of its parent within corresponding dimension in the cube 60; and a property column 744 for each defined property of its corresponding dimension in the cube 60.

The deFact table 75 acts as a place to store user edits until the user decides what to do with them. The deFact table 75 includes: one column 754 per dimension in the cube 60 (including measures); an original value column 752 for original cube cell 65 values, before the user's edit; a new value column 753 containing the user's edit of a cube cell 65 value; and a comment column 756 for storing comments.

The cube 60 may be a “.CUB” file using the PivotTable Services on a Microsoft Windows operating system.

Commit

The commit process 46 writes data to the permanent Fact table 71 from the deFact table 75, which acts as a staging area pending notice whether to save or discard the user's changes. The capture process 40 invokes the commit process 46 when the notice is “save”.

With regard to FIG. 8, the commit process 46 first copies data from the new value column 753 of the deFact table 75 to a corresponding column in the Fact table 71 (step 464). Next, the commit process 46 causes the data cells 529 to be reloaded with current data from the cube 60 (step 466).

Rollback

The rollback process 47 empties obsolete data from the deFact table 75. The data is obsolete because the capture process 40 invokes the rollback process 47 to discard a user's changes.

With regard to FIG. 9, the rollback process 47 loads each entry of the deFact table 75 (step 474). For each entry, the rollback process 47 copies data from the original value column 752 of the deFact table 75 to a corresponding column in the cube 60 (step 476). Subsequently, and also for each entry, the rollback process 47 removes the entry from the deFact table 75 (step 477). After all entries have been processed (completion of step 474), the rollback process 47 causes the data cells 529 to be reloaded with current data from the cube 60 (step 479).

Alternate Embodiments

A number of embodiments of the invention have been described. Nevertheless, it will be understood that various modifications may be made without departing from the spirit and scope of the invention.

For example, FIG. 1C shows an embodiment in which the editing process 40 is available via a wizard process 24 within the spreadsheet application 22. The wizard process 24 includes a dialog that manages a structured sequence of user interactions with predetermined tasks, namely, the steps of the editing process 40 as disclosed above.

In a further embodiment, FIG. 1D shows the spreadsheet application 22 having a spreadsheet add-in facility 224 which includes the wizard process 24. A spreadsheet add-in is a software program configured to install into the spreadsheet application 22 such that the spreadsheet add-in acts as an extension of the features of the spreadsheet application 22. Such features include the user interface as well as programming interfaces which the spreadsheet add-in facility 224 exposes to the wizard process 24 via a user interface API 226 and a programming API 228, respectively. The user interface API 226 allows the wizard process 24 to create and control user interface elements, including sheets, menus, and dialogs, within the spreadsheet application 22. The programming API 228 gives the wizard process 24 access to programming interfaces such as externally manipulable methods and properties of the spreadsheet application 22 itself. The spreadsheet add-in facility 224 for a given spreadsheet application 22 is known in the art; technology and techniques are usually published by the software company that manufactures the spreadsheet application 22.

Alternate embodiments may also include the following. Other spreadsheet applications than Microsoft Excel may be used. Instead of Microsoft Access, the cube storage 62 may be Microsoft SQL Server, or Oracle Enterprise Server, or comparable databases that store multidimensional data. Data definition languages and data manipulation language other than MDX are possible, according to the database used to provide cube storage 62. The operating system 631 may be Apple MacOS, a handheld device OS, or any OS that can provide a spreadsheet application 22 and appropriate services. The mapping that associates data cells 529 with locations in the cube 60 might not be performed using a link sheet 58, a coordinate sheet 56, and a detail sheet 54, but might be performed via some other lookup mechanism providing an equivalent result through different means, such as a database of mapping entries. The functionality of the deFact table 75 to log user edits, enabling selective commits and rollbacks, might be provided within the cube storage 62 itself. Accordingly, other embodiments are within the scope of the following claims.

What is claimed is:

1. A computer-based method for multi-dimensional data entry in a spreadsheet application, the method comprising:
providing a multi-dimensional data storage source;
configuring a spreadsheet to display a plurality of elements of the multi-dimensional data storage in an initial unedited state;
allowing a user to edit a data value of an element in the plurality of elements;
displaying the edited data values in the spreadsheet; and
allowing the user at least two options, one option being to commit the edited data values to the multi-dimensional data storage, a second option being to return the multidimensional data storage to the initial unedited state.

2. The method of claim 1, wherein configuring a spreadsheet further comprises:
using spreadsheet-based data structures to enable a correspondence between a spreadsheet data cell and a cell in the multi-dimensional data storage source.

3. The method of claim 1, wherein allowing the user to edit a data value further includes:
storing the edited data values individually in a data storage source separate from the multi-dimensional data storage source.

4. The method of claim 1, the method further comprising, after the displaying step and before the step of allowing the user at least two options, a step of:
allowing the user to discard an edit to the edited data values without discarding every such edit.

5. The method of claim 1, wherein an interactive dialog wizard guides at least part of the user's interaction with the method.

6. The method of claim 1, wherein the method is implemented as an add-in to the spreadsheet application.

7. A computer apparatus for multi-dimensional data entry in a spreadsheet application, the apparatus comprising:
a central processing unit, random-access memory, a storage device, and devices for user input and output interconnected by a bus, together with computer-readable instructions capable of causing the processing unit to perform the steps of:
providing a multi-dimensional-data storage source;
configuring a spreadsheet to display a plurality of elements of the multi-dimensional data storage in an initial unedited state;
allowing a user to edit a data value of an element in the plurality of elements;
displaying the edited data values in the spreadsheet;
allowing the user to discard an edit to the edited data values without discarding every such edit; and
allowing the user at least two options, one option being to commit the edited data values to the multi-dimensional data storage, a second option being to return the multidimensional data storage to the initial unedited state.
